(19) United States
(12) Patent Application Publication
(10) Pub. No.: US 2023/0129449 A1
(43) Pub. Date: Apr. 27, 2023

(54) Method for Recording Inspection Data of Printed Products

(71) Applicant: BST GmbH, Bielefeld (DE)

(72) Inventors: Oliver Van Pels, Leopoldshöhe (DE); Ulrich Kohl, Bielefeld (DE); Christian Lohmeier, Bielefeld (DE)

(21) Appl. No.: 17/801,667

(22) PCT Filed: Mar. 1, 2021
(86) PCT No.: PCT/EP2021/055016

§ 371 Date: Aug. 23, 2022

(30) Foreign Application Priority Data
Mar. 2, 2020 (EP) 20160381.8

(51) Int. Cl. B41F 33/16; B41F 33/00

(52) U.S. Cl. CPC B41F 33/16; B41F 33/0036

(57) ABSTRACT

A method of recording inspection data relating to print products formed on a printing press, the print products including a sequence of repeating format images, the method including the step of storing digital images of defective parts of a print product, wherein a compressed video stream of a regular sequence of the format images is stored for at least a clipping of the repeating format.

The invention relates to a method for recording inspection data relating to print products that have been formed on a printing press and comprise a sequence of repeating formats, the method comprising a step of storing digital images of defective parts of the print product.

It is common practice in the printing industry that, during operation of a rotary printing press, a so called web observation is performed, wherein images of selected clippings of the formats to be printed are captured with a stroboscopic camera and are displayed on a screen, so that the operator can monitor parts of the printed image that are particularly critical in view of possible undesired changes. Moreover, inspection systems are known with which the entire printed web is inspected during the production process and/or when the production process is completed, in order to detect defects in the print result and possibly cut out the defective parts of the printed web. Such an inspection system may for example comprise a line camera for scanning the running printed web on its entire width, so that digital images of all printed formats are obtained. The captured images may be inspected visually by human personnel or may be searched for defects by means of digital image processing, typically by comparing the respective captured digital images to a reference image that represents the desired result.

However, due to the large amount of data, the image file that is obtained in this way is too voluminous to be stored over an extended period of time. It has therefore been common practice that, in the inspection process, a digital inspection protocol is established that has a significantly reduced data volume. This may for example be done by limiting the stored images to the direct vicinity of a detected defect and/or by reducing the image resolution in case of large-area defects. Other possibilities comprise selecting and storing only one representative image from a sequence of defects of the same type. Moreover, commonly used compression techniques such as JPEG and the like may be employed. The approved material on which no defects have been found will only be documented as images in the form of samples or will not be documented at all.

These known methods have the drawbacks that the automatic error detection will only launch above a certain detection threshold and is generally less sensitive than the human eye. If, however, the storage of the image data starts only upon detection of the first error, there is no longer a possibility to check the parts of the web that have been inspected earlier for less prominent occurrences of the gradually developing defect. If the image resolution is reduced, then defects that extend over a large area but have a fine structure, such as register errors, can no longer be recognized. If only individual representative defects are stored, it is not possible to reconstruct the time development and dynamics of the error. If the frequency of an error increases, it is no longer possible to retroactively re-inspect the material that has already been inspected earlier. The same applies when the detection criteria are changed retroactively.

It is an object of the invention to improve the quality of the inspection of print products and the documentation of the inspection results while keeping the required data storage capacity in limits.

According to the invention, this object is achieved by a step of storing, at least for a clipping of the repeating frame, a compressed video stream of a regular sequence of format images.

Thus, the video stream consists of a sequence of digital frames that render, without gaps, all successively printed format images over a certain period of time. In comparison to storing individual error images, this method has the advantage that the dynamic development of the errors can be tracked over time. When compressing the image data, it is possible to take advantage of the fact that the successively printed format images will ideally have the same image content, so that the digital frames have a high redundancy. This allows for a data compression with a very high compression rate, for example by storing only the (comparatively small) changes from image to image. In this way, given a limited storage capacity, it is possible to establish a comprehensive documentation of the inspection results, for example by lowering the detection threshold, so that the quality of the inspection is improved significantly.

The term “regular sequence” shall designate a sequence of format images that either comprises all format images without gaps or consists of every second, every third, etc. image in the sequence and thus represents a time lapse video stream.

More specific embodiments and further developments of the invention are indicated in the dependent claims.

In one embodiment, the recording of the video stream is triggered only when an error has been detected in the automatic inspection or the extent of the error has exceeded a pre-defined threshold value. In other embodiments, the recording is triggered only when a repeating error has been detected or when the error frequency increases.

The recording may be limited to a small clipping of the format in which the error has occurred.

In another embodiment, the entire format is continuously recorded during the entire production process, so that one obtains a compressed but gapless video stream of the complete print product. In this case, the method has the advantage that the history of an error can also be checked retrospectively when the error has been noticed only in a relatively late stage in the production process. Likewise is it possible to retroactively change the detection criteria and to repeat the inspection with the new criteria, based on the recorded video stream.

Preferably, each frame in the recorded video stream has assigned a number that indicates the time of printing and the position of the corresponding format image on the web of printing material, respectively.

In an advantageous embodiment, the video file includes also, for each frame or respectively for a group of several frames, an annotation field in which comments on the inspection result may be entered and stored, preferably with a respective reference to the position in the frame to which the comment applies.

The method is applicable not only with rotary printing presses but also in digital printing. In the latter case, it is possible to segment web of printing material into several lanes which may have different repeats. Then, the recording method according to the invention can optionally be performed separately in each lane and independently of the recording in the other lanes.

An embodiment example will now be described in conjunction with the drawings, wherein:

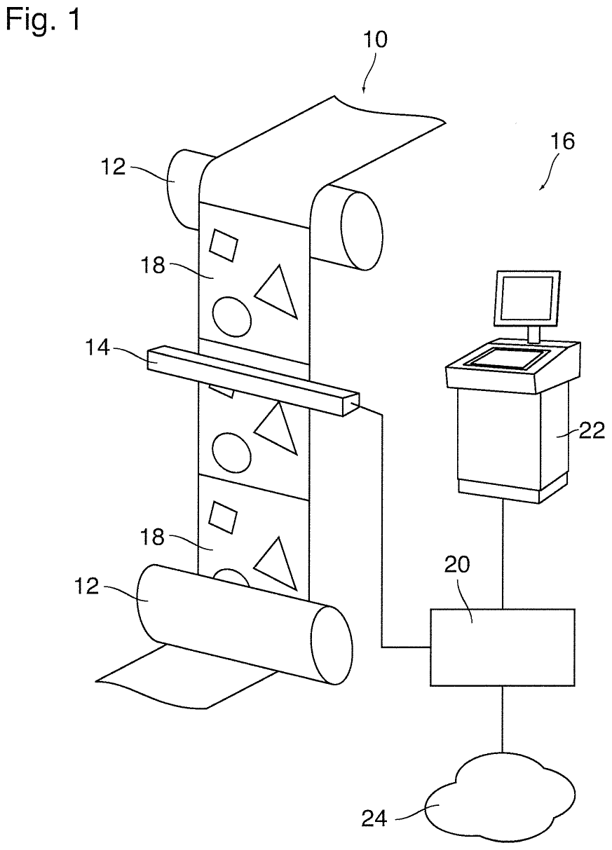

FIG. 1 is a principle sketch of a web inspection system in a rotary printing press;

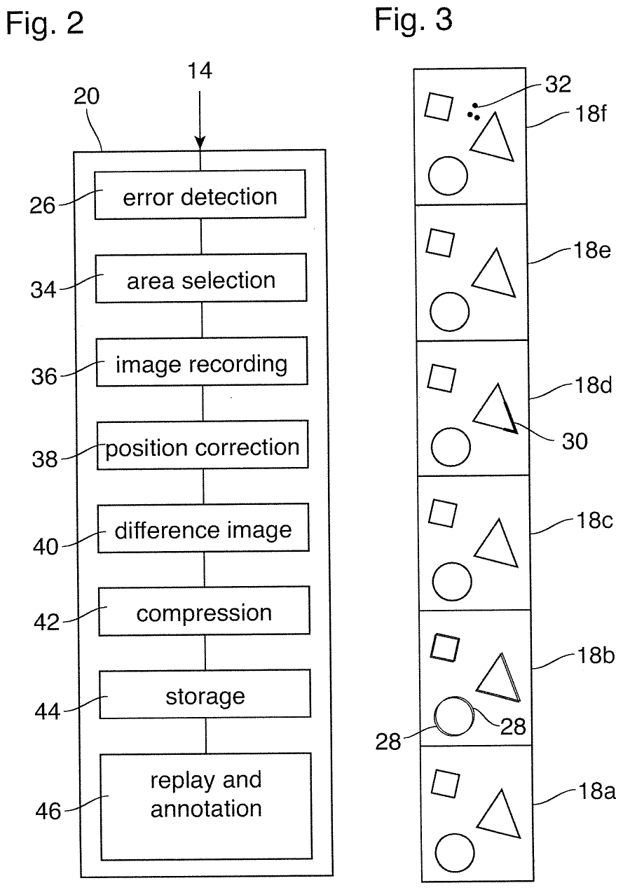

FIG. 2 is a block diagram of an inspection system with which the method according to the invention can be practiced;

FIG. 3 shows a sequence of format images that have been printed on a web of printing material and have several kinds of errors:

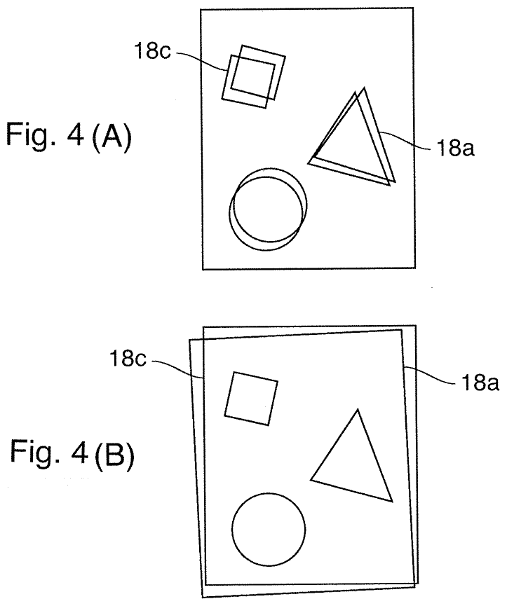

FIG. 4 is a diagram illustrating a method for position correction of digital images in the method according to the invention; and

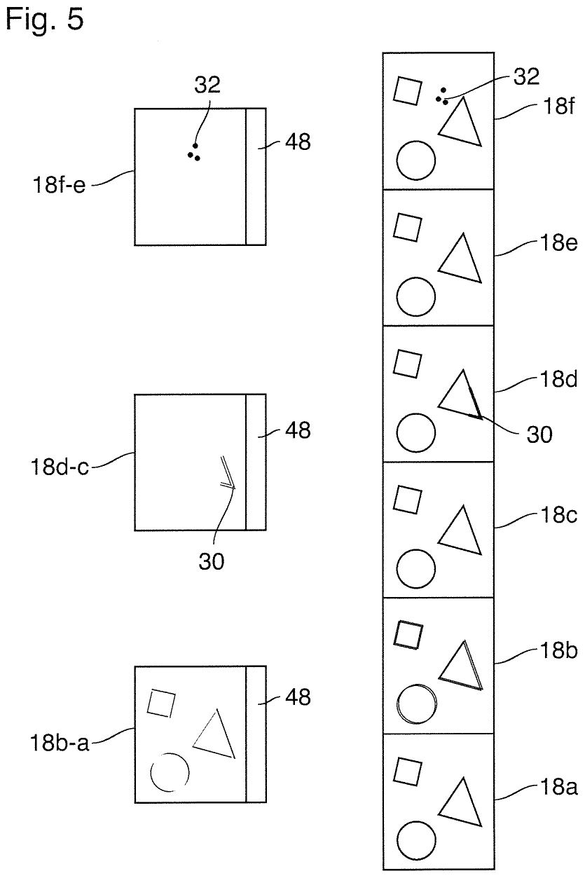

FIG. 5 is a diagram of a method of data compression in the process of forming a video stream according to the invention.

FIG. 1 shows a portion of a web 10 of printing material that is trained over deflection rollers 12 a rotary printing press and runs past a line camera 14 that extends over the entire width of the web and forms part of an inspection system 16. In the printing press, a sequence of repeating format images 18 has been printed onto the web 10. These format images are scanned with the line camera 14 and are recorded digitally. For processing the digital image data, the inspection system comprises an electronic evaluation system 20 that communicates with a user interface 22 and a network 24 (Internet).

FIG. 2 shows several processing stages of the evaluation system 20. In a error detection stage 26, the data supplied from the line camera 14 during operation of the printing press are analysed by means of digital image processing techniques, and the digital copies of the format images 18 are checked in real time for possible errors in the printed images on the basis of certain detection criteria. The necessary methods for error detection are known per-se and are not described here in greater detail.

In order to illustrate several types of error, FIG. 3 shows a sequence of digital images 18a-18f that are renderings of the format images 18 that have successively been printed onto the web 10. In the example shown, the images 18a, 18c and 18e are error-free. The image 18b illustrates a register error wherein two colour component images 28 in the format image are slightly offset from one another. The image 18d illustrates a colour density error, wherein somewhat too much ink has been applied on the right margin of the web due to a non-uniform impression of a printing cylinder, so that the colour density and/or the hue is compromised.

Finally, the image 18f illustrates an error which consists in splashes 32 of ink that have contaminated the web.

The errors illustrated in images 18b and 18d are due to incorrect settings of the printing press and will therefore not occur sporadically between error-free images, as has been shown in the simplified drawing in FIG. 3, but will occur repeatedly in a large number of successive format images, although the intensity of the error may vary over time.

When an error has been detected in the error detection stage 26, a certain area of the format in which the detected error is localized may automatically be selected in a following area section stage 34 (FIG. 2). For example, in case of the splashes 32, a small clipping of the format would be selected that includes the splashes. In contrast, the register error in image 18b is distributed over the entire area of the format and can therefore, in principle, not be localized more closely. Nevertheless, it is possible to select an image area in which the register error is visible particularly clearly.

In an image recording stage 36, the recording process is started for establishing a video protocol. This includes storing the digital data of the selected image areas in a working memory.

Optionally, the inspection system may be programmed such that the entire format is selected in the area selection stage 34, so that, practically, no area selection takes place. Likewise, the system can be programmed such that the image recording in the image recording stage 36 starts immediately at the start of the production process, independent of a detection of any errors.

In the course of the production process, a substantial amount of data will be accumulated, in particular in case of the two variants of the method discussed in the foregoing paragraph, so that a substantial data compression is necessary. Basically, this data compression is based on the fact that, ideally, if all format images on the web were free of errors, the corresponding digital images 18a-18f would be identical to one another, so that, if two digital images are selected arbitrarily and the image data are subtracted from one another, the resulting difference image would have no content. In that case, it would be sufficient to store only a single digital image, e.g. the image 18a, without any loss of information on the production process.

In contrast, in the example shown in FIG. 3, the difference image of the images 18a and 18b would not be empty, because the image with register error is different from the image without register error. The difference image of the images 18c and 18d would have content only at the location of the colour density error 30 while the rest of the image would be empty, so that the data volume could be reduced significantly by means of conventional compression techniques. The same applies to the difference image of the images 18e and 18f, in which only the splashes 32 would be left over.

In practice, however, things are somewhat complicated by the fact that the lateral position and the running direction of the web 10 relative to the line camera 14 may vary slightly in the course of the production process. The speed of the web transport may also have certain fluctuations, leading to position errors in the running direction of the web. It is therefore convenient to subject the digital images to a position correction in a position correction stage 38 before the digital images are compared to one another. This procedure has been exemplified in FIG. 4 for the error-free images 18a and 18c. In part (A) of the figure, the two digital images 18a and 18c have been superposed, so that the image contents are offset and rotated relative to one another due to the position error. In part (B), the image 18a has been shifted and rotated such that the image contents are congruent. When the difference image is calculated in this state, only the true errors will show up in the difference image.

In practice, due to the errors present in the images, it will of course generally not be possible to make the image contents completely congruent. However, it is always possible to shift and rotate the images such that the deviations between the image contents are minimized. In the case of register errors, it is possible to focus on a single colour component image, so that the image contents can be made congruent for this one colour component image. The difference remaining in the other colour component images will then represent true register errors.

Under certain circumstances, the scaling of the image captured by the line camera 14 may also vary in the course of the production process, for example due to thermal expansion of the line camera. In that case, it may be necessary in the position correction stage 38 to perform also a scale correction in order to achieve a best possible congruence of the image contents.

Then, in a difference image stage 40, the difference image is calculated for each pair of digital images 18a-18f for which the position correction has been performed. FIG. 5 shows examples of difference images 18f-e, 18d-c and 18b-a for the pairs of images 18f and 18e, 18d and 18c as well as 18b and 18a.

For errors that occur only sporadically, such as the splashes 32, it will generally be sufficient to compare two format images that are immediately adjacent to one another in the sequence. For errors that vary only slowly in their amount, such as the colour density error 30 and the register error, the different between one image and the next may be below the detection threshold. In order to be able to detect and record also errors of this type, it is convenient to generate difference images also for pairs of digital images that are separated by a greater time interval in their capturing times.

When all difference images (up to the image that has currently been captured by the line camera) have been calculated, the image data of each difference image are compressed in a compression stage 42 by means of conventional algorithms, and the compressed data are stored as a compressed video stream in a storage stage 44. Likewise, a compressed version of the image that has been captured first, e.g. the image 18a, is stored as a reference image. In this way, the overall data volume is been reduced so much that the video stream may be stored as a video protocol over a longer period of time, if necessary. If a closer inspection is desired, the video sequence may be reconstructed from the stored reference image and the stored difference images in a replay stage 46 and may be displayed on the user interface 22, the video sequence reflecting the entire production process practically without loss of information. It is a particular advantage that, when viewing the video, the dynamic development of the errors can be monitored in real time or optionally in slow motion or time lapse. In case of slowly varying errors for which only difference images of format images have been stored that are separated by a large distance, the changes in the intervening frames may be reconstructed by interpolation.

It will be understood that a frame number is stored for each difference image, said frame number indicating the format image on the printed web to which the difference image refers. When the print process has been completed, it is possible on the basis of this frame number to virtually “rewind” the entire print product and to scroll the video protocol to any point of interest on the printed web. As has been shown in FIG. 5, the compressed video stream includes also an annotation field 48, at least for some of the difference images, in which comments and annotations and other information may be entered for each format image or each group of format images on which a certain error is visible. All this information may also be made available to other users via the network 24.

What is claimed is:

1. A method of recording inspection data relating to print products formed on a printing press, the print products comprising a sequence of repeating format images, the method comprising the step of storing digital images of defective parts of a print product, such that a compressed video stream of a regular sequence of the format images is stored for at least a clipping of the repeating format.

2. The method according to claim 1, wherein the compressed video stream represents the complete format.

3. The method according to claim 1, further comprising the steps of, during a production process:
inspecting the digital images by an error detection algorithm and
triggering recording of the video stream only when a pre-defined detection condition is met.

4. The method according to claim 1, further comprising the step of generating the compressed video stream by calculating difference images of digital images which represent format images that have been printed at different times.

5. The method according to claim 4, further comprising the step of subjecting the digital images to a position correction before the difference images are calculated.

6. The method according to claim 1, further comprising the step of storing annotation information that refers to individual frames or groups of frames in the compressed video stream in addition to the image data.
